(19) United States
(12) Patent Application Publication
(10) Pub. No.: US 2015/0306749 A1
(43) Pub. Date: Oct. 29, 2015

(54) ENERGY-EFFICIENT ELECTRIC SCREW DRIVERS

(71) Applicant: Hsiu-Lin Hsu, New Tapei City (TW)

(72) Inventor: Hsiu-Lin Hsu, New Tapei City (TW)

(21) Appl. No.: 14/263,078

(22) Filed: Apr. 28, 2014

(51) Int. Cl. B25B 21/00

(52) U.S. Cl. CPC B25B 21/008

(57) ABSTRACT

An energy-efficient electric screw driver equipped with MCU, and has three adjustment modes, including: Sport, Normal and ECO. Meanwhile, the capacitor is mounted in the control panel of the electric screw driver and is combined with the battery for use. MCU can limit and change current at different torsions and startup current when the rotating speed is constant. The battery current output can be controlled. At different modes, the power saving effect can be achieved. Lower current also reduces battery temperature, saves power and prolongs battery life.

### BACKGROUND OF INVENTION

1. Field of the Invention

The present invention relates generally to an electric screw driver, and more particularly to an energy-efficient electric screw driver which is environment friendly, and can save energy and costs.

2. Description of Related Art

The power supply of general electric screw drivers has been changed from power outlets to rechargeable battery. They are not limited by power sources; however, rechargeable battery has time limitation. Thus, electric screw drivers cannot be used if the power is lower.

Generally, maximum horsepower is used regardless of torsion when the electric screw drivers lock the screws, and users seldom adjust the torsion to the maximum. Normally, the maximum value ranges from 30% to 80%. Especially, horsepower at the maximum torsion during operation may cause high temperature of screw driver, energy consumption and reduce service life.

The electric screw drivers are a small automatic tool operated by hand. However, due to limited storage of battery, the battery power may use up unconsciously in use.

### SUMMARY OF THE INVENTION

The primary objective of the present invention is to provide an energy-efficient electric screw driver, which is equipped with the MCU to prolong the battery service time and increase use efficiency. Furthermore, different functions of the electric screw driver can be selected at different torsions through switching operation of various energy-saving modes.

The second objective of the present invention is to provide an energy-efficient electric screw driver, which can increase service life of the battery, and has substantial effect on CO2 emission reduction and energy saving.

The third objective of the present invention is to provide an energy-efficient electric screw driver, which MCU setting can accomplish database establishment, tool fault maintenance and repair detection, self recording, screw count times, work area control and multi-functional efficiency of USB information output.

In order to achieve these purposes, the inventor designs a novel energy-efficient electric screw driver. The MCU of energy-efficient electric screw driver is used to set three energy-saving adjustment modes, including: Sport, Normal and ECO; the internal control panel of the electric screw drivers has capacitor coupled with batteries. The MCU in the internal control panel is used to limit current different torsions and output start-up current at different modes when rotating speed is constant, and the battery current output can be controlled. At different energy-saving modes, the power can be saved, and meanwhile, power saving also reduces battery temperature. Power saving can prolong the service life of the battery.

Said ECO means soft start-up mode when the range of the torsion output and battery electric output is 30%˜50%.

Said Normal means normal start-up mode when the range of torsion output and battery electric output is 50%˜80%.

Said Sport means rapid startup mode when the range of torsion output and battery electric output is 80%˜100%.

When said ECO or Normal of electric screw drivers is started up and load is greater than output horsepower, the screws cannot be locked. The MCU can automatically switch ECO or Normal to Sport to lock the screws.

The MCU setting further includes: databank establishment, automatic repair detection of tool faults, self-recording, screw counts, work area control and USB information output function.

Although the invention has been explained in relation to its preferred embodiment, it is to be understood that many other possible modifications and variations can be made without departing from the spirit and scope of the invention as hereinafter claimed.

### BRIEF DESCRIPTION OF THE DRAWINGS

FIG. 1 is the external view of the electric screw driver.

FIG. 2 is the bottom view of the electric screw driver.

FIG. 3 is the circuit diagram of control device.

FIG. 4 is the ECO flow chart.

FIG. 5 is the Normal flow chart.

FIG. 6 is the Sport flow chart.

FIG. 7 is the flow chart of the control device.

FIG. 8 (A) is the comparison of the actual motor current of the invented driver with the general electric screw driver when charge-discharge of the batteries exceeds 500 times.

FIG. 8 (B) is the comparison of the actual motor current of the invented driver with the general electric drive when new batteries are used.

FIG. 8 (C) is the comparison of the screw locking times at different modes when the batteries have the same capacity and are full.

FIG. 8 (D) is the comparison of temperature change of the invented electric screw driver with general electric screw driver at the normal service time

### DETAILED DESCRIPTION OF THE INVENTION

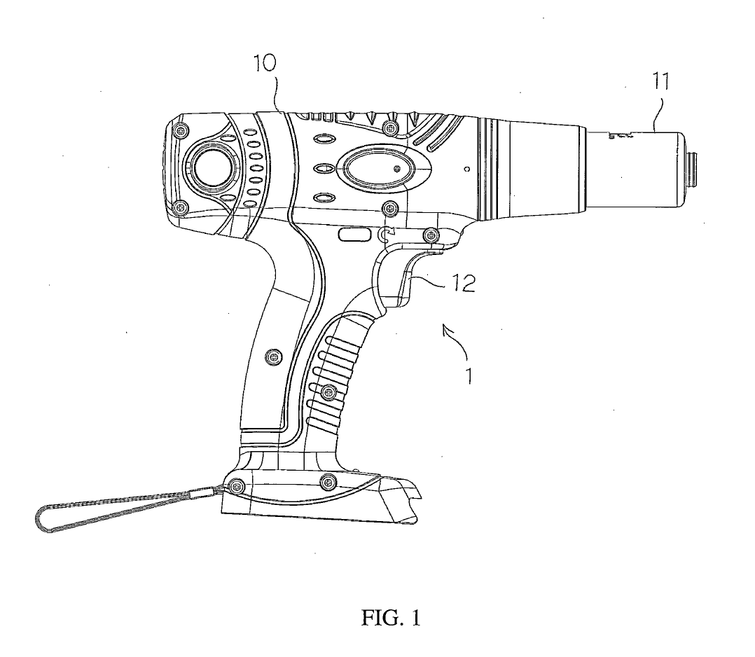

FIG. 1 shows an energy-efficient electric screw driver. The electric screw driver 1 is rechargeable, equipped with one set of matched housing 10. The housing 10 is not intended to limit the invention, such as pen type and gun type. In the present invention, inside of the housing 10 comprises: Motor device (not shown in the figure), gear unit (not shown in the figure), clutch (not shown in the figure), grip 11, trigger 12 and control device (not shown in the figure); these devices are basic structure and functions of the general (brushless) electric screw drivers. The focus of the patent application is not described repeatedly:

This invented electric screw driver can be further used in the accelerator (or booster) of this inventor with patent No M444913. The accelerator is mounted on the power output shaft of the motor to accomplish the soft startup mode. In this way, the (brushless) motor horsepower can be increased by one time. However, the power consumption is increased by 30%. This method can shorten screw locking time and increase work efficiency; one device for torsion adjustment is mounted on the jig 11 (not shown in the figure) of the energy-efficient electric screw driver to prevent improper adjustment of the torsion value from affecting locking quality and effectively manage the product quality.

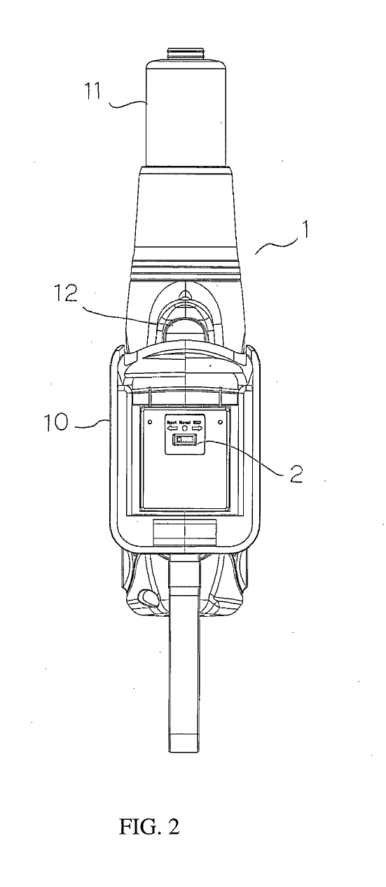

Referring to the FIG. 2, the present invention combines electric screw drivers with multifunctional MCU. The new designed functions of the MCU (2) include: database establishment (total locking times of screws, work frequency per time, and OK/NG frequency), and regular check can effectively manage the work quality; automatic repair and detection of tool faults (including over temperature display, over current display, over voltage display, startup damage, MOS damage, MCU damage, and brake damage) to facilitate repair; self recording (including tool coding, LED selection, buzzer selection, steering selection, startup time setting, brake time setting and operation time setting) to save power and conduct work management; screw count (including OK/NG frequency display, screw length setting, screw angle setting), and this can reduce error rate of screw locking; the work area control (only for specific area), and non-specific area is not allowed, and this can reduce error and improve quality management; USB information output (all data are connected to PC, and after being downloaded, accessed and recorded, they are connected to main PC for quality management and operation of said functions, so as to facilitate input management and reduce error). Counter display and data input device are not required to be purchased at the same time, and thus operation and management is convenient.

Referring to FIG. 2, the energy-efficient electric screw driver is equipped with said MCU 5, and further a capacitor is mounted in the internal structure and coupled with rechargeable battery to provide power for startup of the screw driver 1. In the subject embodiment, the control device structure comprises: ECO switch 2, capacitor 3, MOSFET 4 and MCU 5; output of the control device is electrically connected with the rechargeable battery 6, and the output is electrically connected with motor 7.

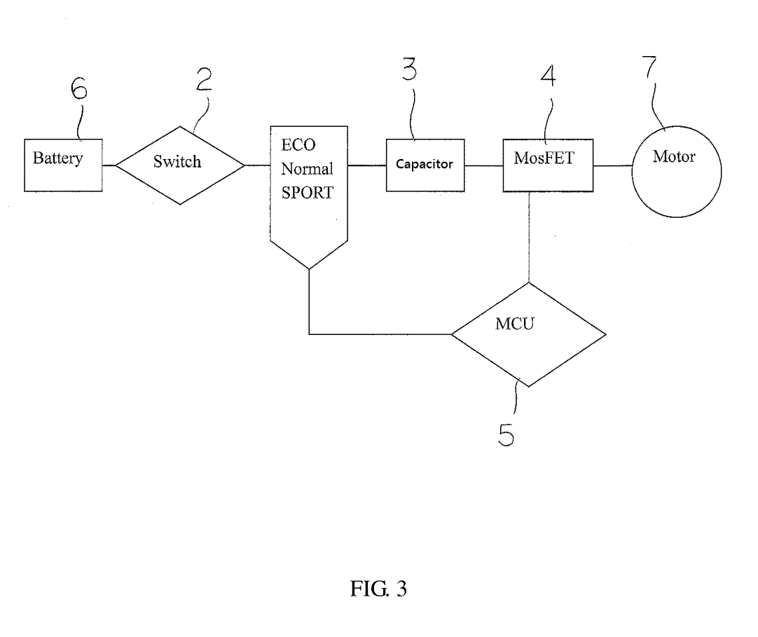

Referring to FIG. 3, the action principle of the control device is: The startup current is output from battery 6, and the switch 2 has different power saving modes. MCU 5 can make different curette output (50%, 80% and 100%), and other current is supplied by Capacitor 3. MCU controls MOSFET 4 to drive and start up the motor 7. Thus, in the present invention, the control device is mainly used to control normal startup, use and current of the electric screw drivers, and the rotating speed is not changed. The efficiency and quality of screw locking is not affected.

The operation of the energy-efficient electric screw drivers at different modes and the functions are described as follows: ECO means the torsion output range is 30%˜50%. It makes current output of the motor at soft startup mode; Normal means the torsion output range is 50%˜80%, and the motor is at normal startup mode; Sport means the torsion output range is 80%˜100%, and the motor is at fast startup mode.

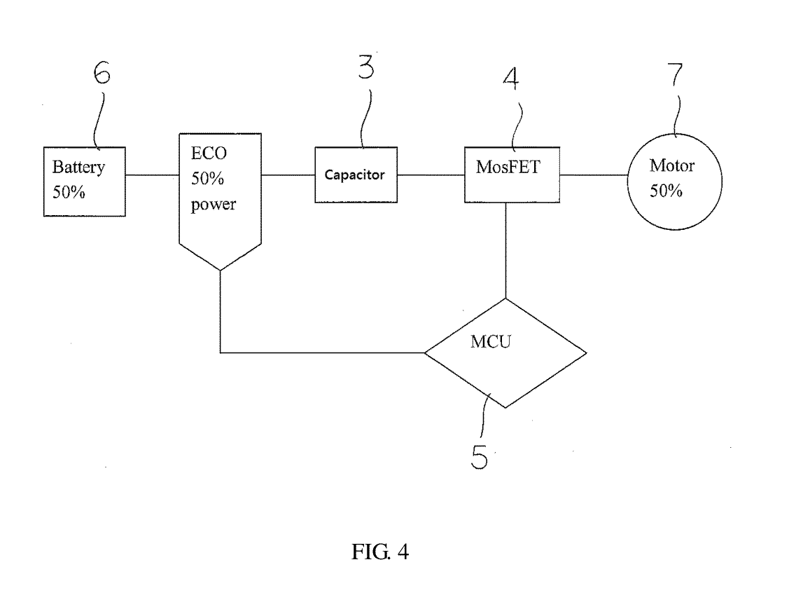

Referring to FIG. 4, after the current supplied by the battery 6 flows through the switch, part of current is stored in the capacitor. MCU 5 is used to control MOSFET 4 to drive the motor 7. Because startup of the motor needs higher current, the high current is supplied by the capacitor 3, and the motor 7 can run upon soft startup. Thus, not all high startup current is supplied by the battery. After the motor 7 runs, the battery 6 supplies continuous power. For efficiency, when the switch is adjusted to ECO, the maximum horsepower of the motor 7 is preset to 50%, and battery supplies 50% of power. At this load, the maximum output horsepower is 50%.

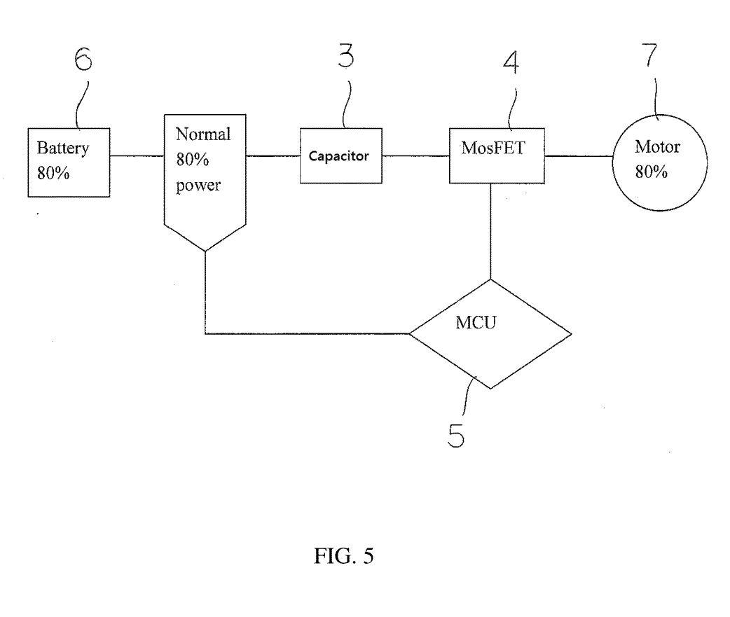

Referring to FIG. 5, when the switch 2 is adjusted to the Normal and the maximum horsepower of the motor 7 is preset to 80%, the battery 6 only supplies 80% of power to drive the motor at Normal. In the subject embodiment, the maximum output horsepower of the motor 7 is 80%.

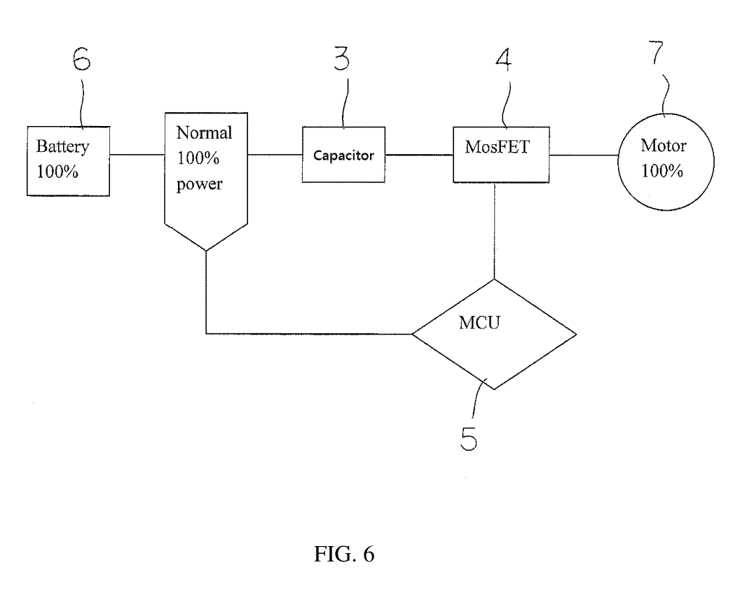

Referring to FIG. 6, when the switch 2 is adjusted to Sport, and the maximum horsepower of the motor 7 is 100% and the battery 6 will supply 100% of power, and drives fast startup of the motor 7. In the subject embodiment, the maximum output horsepower of the motor 7 is 100%.

If load of the energy-efficient electric screw driver at ECO or Normal is greater than the preset maximum output horsepower (50% or 80%), some screw locking may fail. At this time, the MCU 5 may automatically adjust the switch 2 from ECO or Normal to Sport, and the energy-efficient electric screw driver can lock the screws at the minimum power consumption.

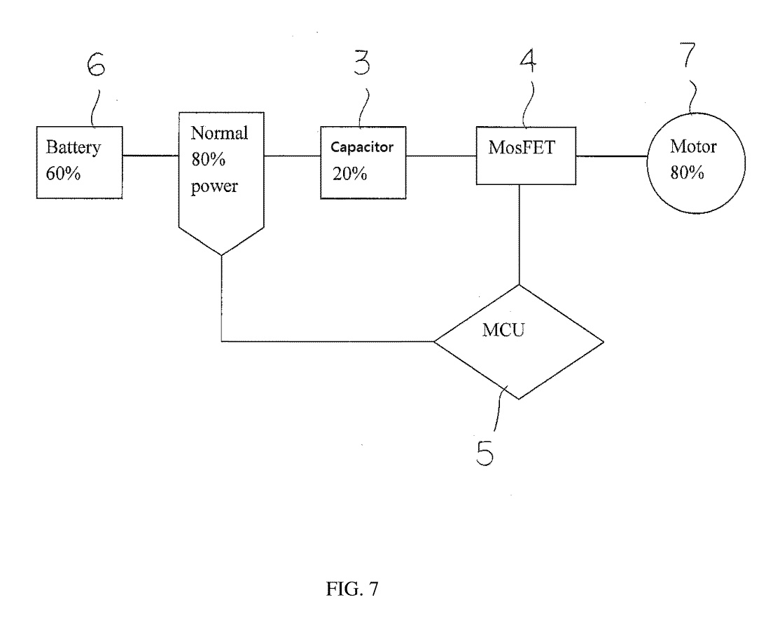

Referring to FIG. 7, ageing may occur if the battery 6 is repeatedly charged, and the power is only 60%. If power of the energy-efficient electric screw driver 1 needs to reach 80%, the capacitor 3 can supply the rest of power to drive the motor 7 and ensure normal work; this can increase battery life, reduce loss of battery power, and reduce energy consumption and CO2 emission.

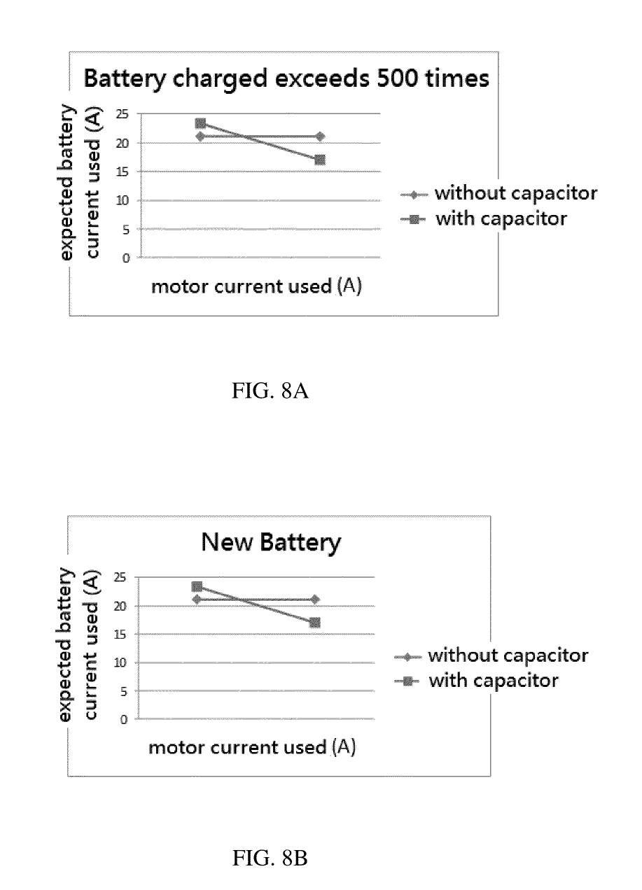

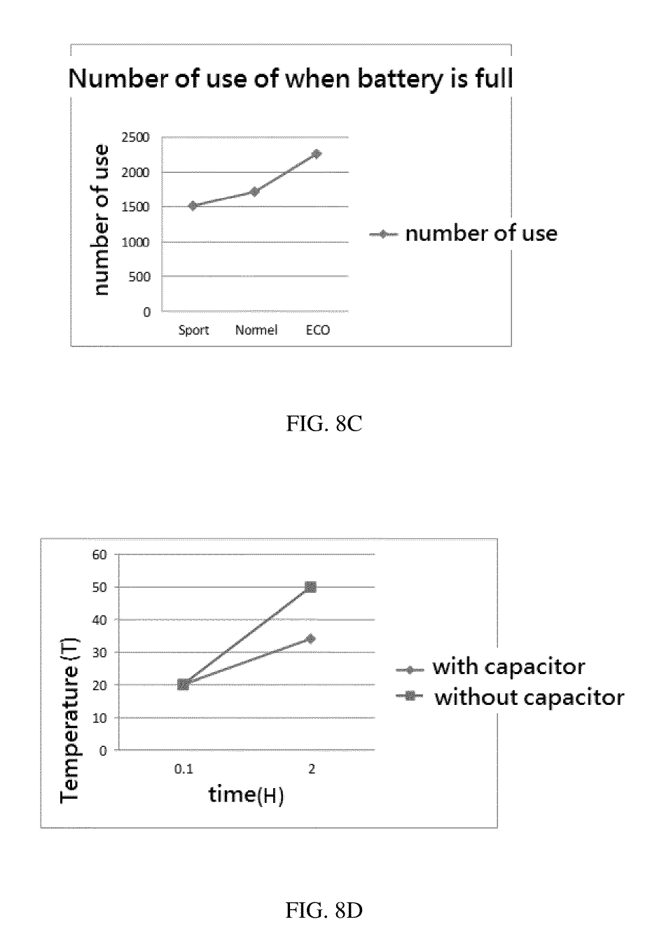

Referring to FIG. 8 (A)-(D), FIGS. 8 (A) and (B) illustrate comparison of the motor current of invented electric screw driver with the general electric screw driver when charging of the batteries exceeds 500 times or the batteries are new. The current supplied by the battery is lower for the invented electric screw driver equipped with the capacitor regardless of using new or old batteries. Based on the actually measured values, 25˜35% of power can be saved, and power saving effect is achieved.

FIG. 8 (C) illustrates times of the screw locking of the invented electric screw drivers at different modes when the battery storage is the same and full. The horsepower and maximum current can obtain maximum torsion output at Sport. After measurement, the screw locking of the invented energy-efficient electric screw drivers reaches 1500 times; at Normal the battery current output is controlled. After measurement, the motor has maximum horsepower, the maximum torque output is 80%, and the locking times are increased by 50%. After measurement, the screw locking can reach 1700 times; at ECO, startup, use and shutdown current and maximum current (maximum current reaches 50%) can be controlled, and the rotating speed is not changed. The threshold current action is made to control current output, and the power can be saved (70% of power can be saved). Furthermore, two times screw locking can be reduced. After measurement, the locking can reach 2300. Thus, effect on the energy-efficient electric screw drivers can be significantly improved.

FIG. 8 (D) illustrates comparison of the temperature change of the invented electric screw drivers with the general electric screw drivers at the normal service time. As shown in the figure, the capacitor mounted in the invented electric screw drivers can be used for 2 hours. The temperature rise is half of the general electric screw driver. In the long time operation, the battery temperature rise is smaller. Thus, the battery life can be prolonged.

1. An energy-efficient electric screw driver with a control device structure of the electric screw driver comprises: an energy-efficient switch, a capacitor, MOSFET and MCU can be connected electrically; the control device output is electrically connected with a battery and the output is electrically connected with the motor.

2. The energy-efficient electric screw driver as claimed in claim 1, wherein energy-saving modes include Sport, Normal and ECO.

3. The energy-efficient electric screw driver as claimed in claim 2, wherein ECO means range of the torsion output and battery output is 30%˜50% and soft startup current output.

4. The energy-efficient electric screw driver as claimed in claim 2, wherein Normal means range of the torsion output and battery output is 50%˜80% and general startup current output.

5. The energy-efficient electric screw driver as claimed in claim 2, wherein Sport means range of the torsion output and battery output is 80%˜10% and rapid startup current output.

6. The energy-efficient electric screw driver as claimed in claim 2, wherein load of the electric screw drivers at ECO or Normal is greater than the output horsepower, and the screw locking cannot be finished; MCU can automatically adjust the switch from ECO to Sport to finish screw locking.

7. The energy-efficient electric screw driver as claimed in claim 2, wherein MCU setting includes: data establishment, automatic repair and detection of tool faults, self-recording, screw count, work area control and USB information output function.
